(19) United States
(12) Patent Application Publication
(10) Pub. No.: US 2022/0012764 A1
(43) Pub. Date: Jan. 13, 2022

(54) SYSTEM AND METHOD FOR LINKING CONSUMER DATA WITH ONE OR MORE SUPPLIERS FOR PRODUCT TRACKING AND VALIDATION

(71) Applicant: HealthLoq LLC, Mesa, AZ (US)

(72) Inventors: Todd Wendell Taylor, Mesa, AZ (US); Kenneth Alden Staker, Mesa, AZ (US); Derek James Lurth, Mesa, AZ (US)

(21) Appl. No.: 17/359,339

(22) Filed: Jun. 25, 2021

Related U.S. Application Data
(60) Provisional application No. 63/049,069, filed on Jul. 7, 2020.
(60) Provisional application No. 63/049,064, filed on Jul. 7, 2020.

(51) Int. Cl. G06Q 30/02

(52) U.S. Cl. CPC G06Q 30/0224

(57) ABSTRACT

A method includes receiving first data including product identification information that identifies a particular instance of a product. The product is associated with a supply chain that includes a plurality of suppliers. The method further includes receiving second data from a consumer of the product. The second data indicates consumer information related to use of the particular instance of the product by the consumer. The method further includes, based on the product identification information and the consumer information, initiating an update to a database to indicate one or more parameters associated with the particular instance of the product. At least a portion of the database is accessible to at least a first supplier of the plurality of suppliers.

### CROSS-REFERENCE TO RELATED APPLICATIONS

The present application claims the benefit of U.S. Provisional Patent Application No. 63/049,069, filed Jul. 7, 2020 and entitled “SYSTEM AND METHOD FOR LINKING CONSUMER DATA WITH ONE OR MORE SUPPLIERS FOR PRODUCT TRACKING AND VALIDATION,” and U.S. Provisional Patent Application No. 63/049,064, filed Jul. 7, 2020 and entitled “MULTI-FACTOR AUTHENTICATION AT POINT OF SALE FOR MULTI-INGREDIENT PRODUCT TRACKING, TRACING, AND AUTHENTICATION.” The present application is also related to U.S. patent application Ser. No. ______, filed concurrently herewith and entitled “MULTI-FACTOR AUTHENTICATION AT POINT OF SALE FOR MULTI-INGREDIENT PRODUCT TRACKING, TRACING, AND AUTHENTICATION.” The disclosures of the above-identified applications are incorporated by reference herein in their entirety.

### TECHNICAL FIELD

This disclosure relates generally to product tracking and validation.

### BACKGROUND

Nutraceutical products and other goods may include certain representations, such as a certification that a particular good includes a particular ingredient or that a particular good has a certain purity percentage. A consumer may use a representation to decide whether to use a particular product or to decide between similar such products.

In some cases, a representation of a product may be difficult for a consumer to verify. For example, product packaging of a nutraceutical product may include a particular representation that would involve complex or expensive testing to independently verify, such as if the product packaging represents a certain proportion or purity of ingredients of the nutraceutical product. In some cases, a representation may indicate a particular source of an ingredient, which may be infeasible or impossible for a consumer to verify. As a result, consumers may have limited access to useful information for decisions as to which product to use, which may result in poor consumer experience.

Further, in some cases, quality of products may vary from one particular instance of a good to another (e.g., from one bottle of a product to another bottle of the same product). In this case, user experience for different instances of the same good may vary, both among different consumers and for a single consumer. As an example, a nutraceutical product may include many different ingredients, and a “bad batch” of one of the ingredients may reduce efficacy of some instances of the product but not others. As a result, a consumer of the product may have a poor experience with a product that might otherwise benefit the consumer.

### SUMMARY

A technique in accordance with some aspects of the disclosure uses a database (e.g., a blockchain-based database that includes a cryptographically-verifiable transaction log) to record information related to operations performed by a supply chain. For example, the operations may include ingredient production, ingredient transportation, ingredient combining, product manufacturing and packaging, product transportation (e.g., to a retailer), and other operations. In some aspects, the database includes information tracking a product through a complex manufacturing process where one material or substance is transformed into a different material or substance (e.g., where almonds are transformed into an oil that is then mixed with additional ingredients).

In one example, after distribution of a product to a consumer, the consumer is prompted to provide product identification information associated with the product (e.g., by scanning a barcode, such as a quick response (QR) code), consumer information, or both. In some examples, the consumer information includes health outcome information associated with use of the product by the consumer (such as a rating of the efficacy of the product). Alternatively or in addition, the consumer information may include demographic information associated with the consumer, such as any medications taken by the consumer, an exercise program of the consumer, nutrition information of the consumer, a health history of the consumer, height of the consumer, weight of the consumer, other information associated with the consumer, or a combination thereof. In some implementations, the consumer information may be anonymized or partially anonymized. In some examples, an incentive may be issued to the consumer to prompt sharing of the information, such as a discount or a coupon. Another example of an incentive is access to at least a portion of the database. For example, in exchange for sharing the information, the consumer may be granted access to a genealogy of the particular product used by the consumer (e.g., where each bottle or package of a nutraceutical has a distinct corresponding genealogy in the database).

Accordingly, information related to each particular instance of a product may be recorded and accessed using a database that facilitates transparent product tracking and verification from early stages of a supply chain (e.g., ingredient cultivation) to end-user results. In some implementations, one or more parties (e.g., a supplier, a retailer, a consumer, or another party) may access at least a portion of the database to verify information, such as representations or certifications. As an example, in some implementations, a nutraceutical product may represent that a particular product includes an organic substance grown in a particular farm or in a particular country. A consumer of the product may access the database to verify the information, such as by verifying the geographic location at which the substance was grown. Alternatively or in addition, one party of the supply chain may access the database to verify information, such as if a product processor verifies the source or other characteristics of ingredients provided by another party. Thus, an amount of product information and reliability of the product information may be improved as compared to certain other conventional techniques in which the consumer (or other party) relies on the representation of a single party as to characteristics of a product. Further, the database may track a product through a complex cycle, such as before and after a transformative process (e.g., a process that transforms almonds into an oil that is then mixed with additional ingredients), which certain conventional tracking techniques may be unable to perform (such as in the case of techniques that track only simple single-ingredient products and that fail to track ingredients through complex transformative processes).

Further, information provided by the consumer may be used to update the database, and a supplier of a substance may access the updated database to determine a quality metric associated with the substance. For example, each instance of a product may be associated with a unique corresponding genealogy in the database that includes health outcome information for multiple consumers, such as if the genealogy includes information tracking a seed to growth into a crop, to harvesting of the crop, to transportation of the crop, to processing of the crop into a product, to packaging of the product into a particular instance of the product with a unique identifier (e.g., QR code), to sale of the product, and to efficacy of the particular instance of the product as perceived by a consumer. As a result, the supplier may determine that one version of the substance is more effective than another version of the substance (e.g., where growing the substance in one farm or using a different set of growing techniques results in better health outcomes as compared to growing the substance at another farm or using another technique). Thus, suppliers and other parties may have access to improved information that enables increased visibility into various aspects of the supply chain.

In addition to increasing visibility for suppliers, vendors, and other parties of the supply chain, techniques described herein may increase visibility of a consumer to aspects of the supply chain. For example, recording the genealogy associated with a product to a blockchain may enable a consumer to identify the sources of ingredients of the product, a transportation schedule of the ingredients, processes applied to the ingredients, or mixing of the processed ingredients, as illustrative examples. As a result, a consumer may be able to learn or verify information about a product, such as a country of origin of the product (or an ingredient of the product) or a classification of a product (such as an organic classification), as illustrative examples.

Further, in some aspects, recording the genealogy associated with a product to a blockchain may enable suppliers, vendors, and other parties of the supply chain to demonstrate compliance with sustainability, social justice, or environmental, social, and corporate governance (ESG) practices. For example, a consumer, government agency, regulatory body, or other party may access the genealogy to verify certain representations of a supplier, vendor, or other party, such as a representation that ingredients of a product are grown or manufactured using a renewable source of energy (e.g., by verifying that ingredients are grown at a farm that is powered by wind energy or hydropower).

In some cases, enabling verification of sustainability, social justice, or ESG practices may reduce certain costs associated with a product. As an illustrative example, certain government agencies or regulatory bodies may in some cases impose fines or penalties for failing to demonstrate compliance with certain sustainability, social justice, or ESG practices. In some cases, a vendor or other party may find it expensive, difficult, or infeasible to demonstrate compliance with such practices, such as if product ingredients are produced in a foreign jurisdiction, or if the supply chain includes a relatively large number of parties. To further illustrate, the data recorded to the blockchain may include testing data related to a product, such as certificates of analysis, third party testing results, and other quality control procedures. Such an approach may remove the need for, or reduce reliance on, one or more intermediaries (e.g., certifiers or watchdogs), as the parties involved in the supply chain may create a peer-to-peer trustless system. As a result, by recording the genealogy associated with a product to a blockchain, certain costs associated with demonstrating and verifying compliance with sustainability, social justice, or ESG practices may be reduced or avoided in some circumstances.

### BRIEF DESCRIPTION OF THE DRAWINGS

FIG. 1 illustrates an example of a system in accordance with some aspects of the disclosure.

FIG. 2 illustrates another example of a system in accordance with some aspects of the disclosure.

FIG. 3 is a flow chart of an example of a method in accordance with some aspects of the disclosure.

### DETAILED DESCRIPTION

It is noted that while the disclosure that follows may be described with reference to a blockchain, it will be appreciated that a blockchain may include or may be implemented using a variety of technologies. For example, it will be appreciated that “blockchain” may refer to (or may implemented using) a distributed ledger technology or a quantum leger technology, whether centralized or decentralized. In other examples, “blockchain” may refer to (or may implemented using) one or more other technologies.

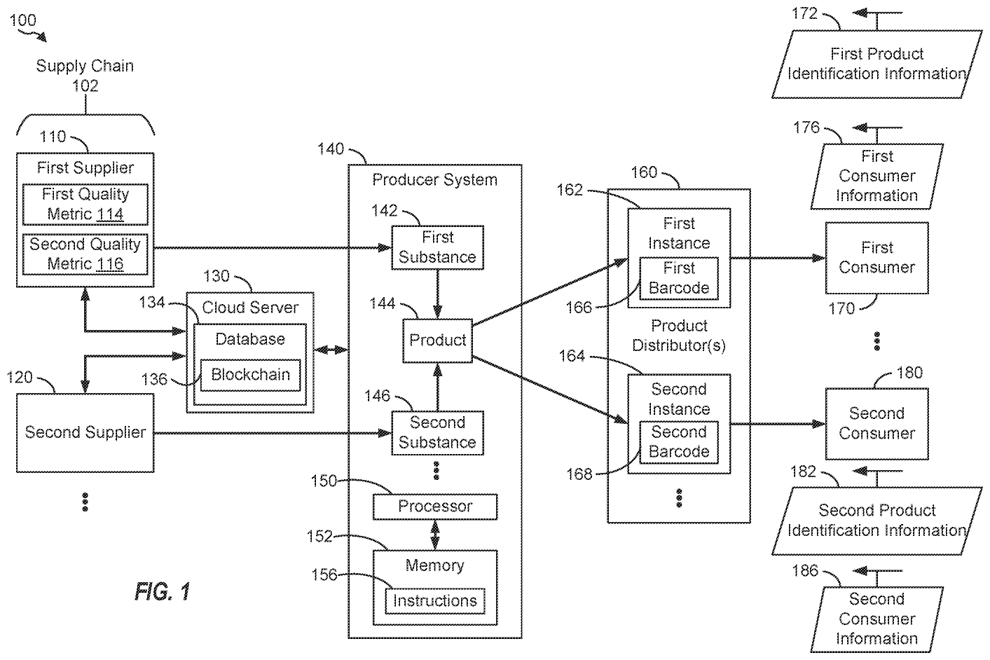

FIG. 1 illustrates an example of a system 100 in accordance with some aspects of the disclosure. In the example of FIG. 1, the system 100 includes a supply chain 102, a cloud server 130, and a producer system 140. The cloud server 130 may store a database 134 (e.g., a blockchain-based database that includes a cryptographically-verifiable transaction log) that is at least partially accessible to multiple devices, as described further below.

The supply chain 102 may include multiple suppliers, such as a first supplier 110 and a second supplier 120. In some examples, the first supplier 110 provides a first substance 142 to the producer system 140, and the second supplier provides a second substance 146 to the producer system 140. As an illustrative example, the first substance 142 may correspond to a particular nutrient, mineral, vitamin, ingredient, dietary supplement, food, pharmaceutical, nutraceutical, material, chemical, or other substance, and the second substance 146 may correspond to another nutrient, mineral, vitamin, ingredient, dietary supplement, food, pharmaceutical, nutraceutical, material, chemical, or other substance.

It is noted that FIG. 1 is illustrative and that the supply chain 102 may include a different number of suppliers (or “links”) than depicted in the example of FIG. 1. For example, although FIG. 1 illustrates that the suppliers 110, 120 may provide the substances 142, 146 to the producer system 140, in other examples, the supply chain 102 includes one or more delivery mechanisms to transport one or both of the substances 142, 146 to the producer system 140. As an example, one or more vehicles may transport one or both of the substances 142, 146 to the producer system 140. In some examples, a delivery mechanism may be partially automated or fully automated. For example, an autonomous vehicle (such as a self-driving car or truck) may receive transport one or both of the substances 142, 146 to the producer system 140. Alternatively or in addition, in some examples, the supply chain 102 may include one or more substance transformation mechanisms. For example, the suppliers 110, 120 may receive a preliminary substance (e.g., milk) and may transform the preliminary substance into the substances 142, 146 (e.g., by using the milk to create cheese or ice cream). Those of skill in the art will recognize that other examples are also within the scope of the disclosure.

In some examples, each operation performed with reference to the supply chain 102 may be associated with a corresponding update to the database 134. To illustrate, the first supplier 110 may create a first entry of the database 134 (e.g., a first block of a blockchain 136 of the database 134) associated with the first substance 142. In some examples, the first entry includes source information verifying one or more aspects of the first substance 142, such as a purity metric associated with the first substance 142, one or more test results associated with the first substance 142, an organic certification associated with the first substance 142, a certification that the first substance 142 complies with one or more laws or regulations, other source information, or a combination thereof. In some examples, a plurality of devices authenticate the first entry using a consensus mechanism, such as if the supply chain 102, the cloud server 130 and the producer system 140 “vote” to authenticate the first entry.

To further illustrate, a delivery mechanism may create a second entry of the database 134 (e.g., a second block of the blockchain 136) associated with delivery of the first substance 142. To illustrate, the second entry may include delivery information associated with the first substance 142, such as a time of pickup of the first substance 142, a time of delivery of the first substance 142, or a weight of the first substance 142, as illustrative examples. In some examples, the second entry incorporates or references the first entry. For example, the second entry may include a hash of at least some information of the first entry to authenticate the second entry. In some examples, the second entry includes the source information of the first entry or includes one or more pointers to the source information of the first entry. In some examples, a plurality of devices authenticate the second entry using a consensus mechanism, such as if the supply chain 102, the cloud server 130 and the producer system 140 “vote” to authenticate the second entry.

The producer system 140 may create a product 144 based on substances sourced from the supply chain 102. For example, the producer system 140 may create the product 144 based on the first substance 142, the second substance 146, one or more other substances, or a combination thereof. In some cases, one or more substances of the product 144 may be provided by the producer system 140 (e.g., where the producer system 140, or a portion of the producer system 140, is included in the supply chain 102).

The producer system 140 may include one or more devices or sub-systems that are operated during production of the product 144, such as a manufacturing system, an assembly system, or a packaging system, as illustrative examples. The producer system 140 may include one or more processors, such as a processor 150, and a memory 152 that stores instructions 156 executable by the processor 150 to initiate, perform, or control certain operations described herein. Further, one or more other devices, components, or systems described herein may also include a memory that stores instructions and a processor that executes the instructions to initiate, perform, or control certain operations described herein.

In some implementations, the producer system 140 may create a third entry of the database 134 (e.g., a third block of the blockchain 136) associated with production of the product 144. For example, the third entry may include product information, such as an indication of a type of process used to create the product 144, a location (e.g., a particular facility) associated with production of the product 144, or other information. In some examples, the third entry incorporates or references the first entry, the second entry, or both. For example, the third entry may include a hash of at least some information of the first entry, at least some information of the second entry, or both, to authenticate the second entry. In some examples, the third entry includes the source information of the first entry, one or more pointers to the source information of the first entry, the delivery information of the second entry, one or more pointers to the delivery information of the second entry, or a combination thereof. In some examples, a plurality of devices authenticate the third entry using a consensus mechanism, such as if the supply chain 102, the cloud server 130 and the producer system 140 “vote” to authenticate the third entry.

The producer system 140 may distribute the product 144 through one or more product distributors 160. To illustrate, the one or more product distributors 160 may distribute (e.g., sell) a first instance 162 of the product 144 and a second instance 164 of the product 144. As an illustrative non-limiting example, the product 144 may correspond to nutraceutical product. The first instance 162 may correspond to a first packaged container (e.g., a bottle or other container) that includes the product 144, and the second instance 164 may correspond to a second packaged container (e.g., a bottle or other container) that includes the product 144. In some examples, the first instance 162 of the product 144 and the second instance 164 of the product 144 may be sealed, such as by applying a hermetic seal to the first instance 162 of the product 144 and the second instance 164 of the product 144. In some examples, the one or more product distributors 160 include or correspond to physical points-of-sale, such as a “brick and mortar” store. Alternatively or in addition, the one or more product distributors 160 may include virtual stores, such as a web-based virtual store that operates using a website, an app, or both. In the example of FIG. 1, the first instance 162 of the product 144 is distributed to a first consumer 170, and the second instance 164 of the product 144 is distributed to a second consumer 180. As used herein, a consumer may also be referred to as a customer or as a user.

In some examples, the producer system 140 may enable a consumer of the product 144 to provide certain information related to the product 144. The information may be input via one or more electronic devices, such as though a website or an app executed by a communication device (e.g., a cellular phone, a laptop computer, a desktop computer, or a tablet computer, as illustrative examples). In some examples, the information is provided to the cloud server 130 (e.g., via a cellular connection, via a local area connection (LAN), via a wireless LAN (WLAN), via the Internet, or a combination thereof, as illustrative examples).

To illustrate, the first consumer 170 may provide first product identification information 172 that identifies the first instance 162 of the product 144, and the second consumer 180 may provide second product identification information 182 that identifies the second instance 164 of the product 144. In some examples, the first product identification information 172 includes or is generated from a first barcode 166 associated with the first instance 162 of the product 144, and the second product identification information 182 includes or is generated from a second barcode 168 associated with the second instance 164 of the product 144. An example of a barcode is a matrix barcode (e.g., a quick response (QR) code) that may be scanned using a scanning capability of a cellular phone, as an illustrative example. Alternatively or in addition, the product identification information 172, 182 may include other information, such as a numerical identifier (e.g., a serial number), which may be input to a web site or to an app in some implementations.

In some implementations, the first consumer 170 provides first consumer information 176 associated with the first instance 162 of the product 144, and the second consumer 180 provides second consumer information 186 associated with the second instance 164 of the product 144. In some examples, consumer information may indicate health status information resulting from the use of the product 144 by a consumer. For example, the first consumer information 176 may indicate efficacy of the product 144 as perceived by the first consumer 170 or a rating of the product 144 by the first consumer 170, and the second consumer information 186 may indicate efficacy of the product 144 as perceived by the second consumer 180 or a rating of the product 144 by the second consumer 180.

In some examples, consumer information may indicate demographic information associated with a consumer. For example, the first consumer information 176 may include demographics of the first consumer 170, such as medications taken by the first consumer 170, an exercise program of the first consumer 170, nutrition information of the first consumer 170, or a health history of the first consumer 170. As another example, the second consumer information 186 may include demographics of the second consumer 180, such as medications taken by the second consumer 180, an exercise program of the second consumer 180, nutrition information of the second consumer 180, or a health history of the second consumer 180.

In some examples, a consumer may provide product identification information and consumer information during a particular interaction with an app or a web site. For example, packaging materials of the product 144 may encourage consumers to register with the app or website. Upon visiting the app or website to register, a consumer may be prompted to provide product identification information and consumer information. In some examples, the consumer is encouraged to provide the product identification information, the consumer information, or both based on an incentive. The incentive may correspond to a discount or a coupon applicable to further purchases, as an illustrative example. In some examples, the incentive may be provided to the consumer in response to detecting that a condition is satisfied. For example, the condition may correspond to providing consumer information. Based on receipt of the consumer information, the producer system 140 may detect that the condition is satisfied, and the producer system 140 may provide the incentive based on detecting that the condition is satisfied.

In an illustrative example, the producer system 140 updates the database 134 to indicate one or more parameters associated with the particular instance of the product 144. To illustrate, in some examples, the database 134 has a hashed linked list data structure, such as a blockchain data structure corresponding to the blockchain 136. In some examples, the database 134 indicates an authenticated history (e.g., a genealogy) of each instance of the product 144. Each authenticated history may include data related to two or more substances associated with the product 144, such as the substances 142, 146. For example, an indication of each substance or production operation associated with each instance of the product 144 may be uploaded to the database 134 and verified using a consensus mechanism. In some examples, an authenticated history of the first instance 162 of the product 144 can be updated to indicate the first consumer information 176, and the authenticated history of the second instance 164 of the product 144 can be updated to indicate the second consumer information 186. In some examples, an authenticated history of an instance of the product 144 may include the first entry, the second entry, and the third entry described above, which may correspond to blocks of the blockchain 136. Accordingly, an authenticated history may enable tracking and validation of the product 144.

In one example, access to a particular portion of the database 134 is provided to a consumer, where the particular portion indicates an authenticated history of a particular instance of the product 144. For example, access to the first authenticated history of the first instance 162 may be provided to the first consumer 170 based on the first product identification information 172 and the first consumer information 176. In one example, the first consumer 170 is provided access to the first authenticated history as an incentive to provide the first consumer information 176. As another example, access to the second authenticated history of the second instance 164 may be provided to the second consumer 180 based on the second product identification information 182 and the second consumer information 186. In one example, the second consumer 180 is provided access to the second authenticated history as an incentive to provide the second consumer information 186. The incentive(s) may be provided by different actors within the supply chain and the feedback or information provided by consumers based on the incentive(s) may be accessible to the actor associated with the incentive (e.g., the actor within the supply chain offering the incentive) and possibly other actors that are authorized to access the feedback or information provided by the consumers. In some examples, smart contracts may be used to distribute incentives to consumers when feedback or other information about a product is provided.

In some examples, access to at least a portion of the database 134 is provided to one or more suppliers within the supply chain 102. For example, the first supplier 110 and the second supplier 120 may have access to the database 134 (e.g., using a password or another authentication mechanism). In some examples, providing access to a supplier enables the supplier to determine quality metrics associated with different instances of the product 144. As an example, the first supplier 110 may determine, based on the database 134, a first quality metric 114 associated with the first instance 162 of the product 144 and a second quality metric 116 based on the second instance 164 of the product 144.

To illustrate, in some cases, the first supplier 110 may obtain the first substance 142 from multiple sources, such as by obtaining a first version of the first substance 142 from a first source and by obtaining a second version of the first substance 142 from a second source different than the first source. As a non-limiting example, the first version may be grown in a first field (or produced from a crop that is grown in the first field), and the second version may be grown in a second field (or produced from a crop that is grown in the second field). As another non-limiting example, the first version may be synthesized in a first laboratory, and the second version may be synthesized in a second laboratory. In some examples, the first instance 162 may include the first version of the first substance 142, and the second instance 164 may include the second version of the first substance 142. In this case, the first quality metric 114 may indicate quality of the first source (based on the first consumer information 176), and the second quality metric 116 may indicate quality of the second source (based on the second consumer information 186).

In some examples, a second update of the database 134 may be performed in response to one or more quality metrics. To illustrate, the producer system 140 may receive an indication of the first quality metric 114 from the first supplier 110, an indication of the second quality metric 116 from the first supplier 110, or both. The producer system 140 may initiate an update of the authenticated history of the first instance 162 of the product 144 to indicate the first quality metric 114 and may initiate an update of the authenticated history of the second instance 164 of the product 144 to indicate the second quality metric 116. In another example, the first supplier 110 may directly initiate the second update of the database 134 (e.g., without operation of the producer system 140 to perform the second update).

Certain devices may be granted limited access to the database 134. For example, the first consumer 170 may be granted limited access to the authenticated history of the first instance of the product 144, such as if the authenticated history of the first instance of the product 144 includes proprietary or sensitive information. As another example, the first consumer 170 may be denied access to the authenticated history of the second instance 164 of the product 144. Thus, certain devices or parties may be granted limited access to the database 134, such as permission-based access.

Although certain examples of FIG. 1 are described with reference to nutraceuticals or other ingestible substances, it is noted that the substances 142, 146 and the product 144 may correspond to a variety of materials, devices, or components. For example, the substances 142, 146 may correspond to electronic components, mechanical components, or industrial supplies, and the product 144 may correspond to an electronic device, a mechanical device, or an industrial device. Those of skill in the art will recognize that other examples are also within the scope of the disclosure.

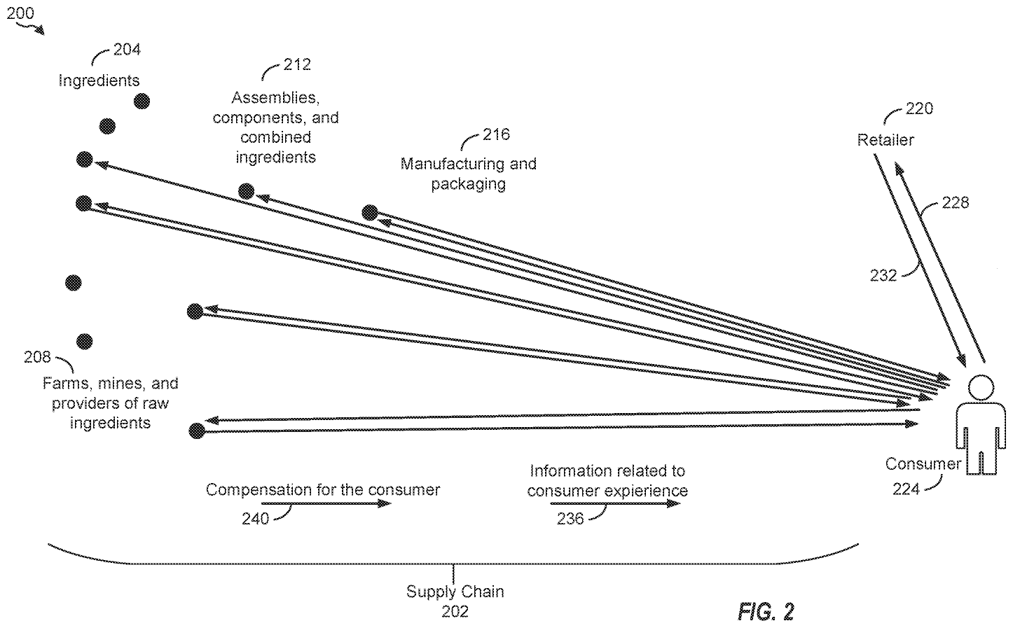

FIG. 2 is a diagram illustrating another example of a system 200 in accordance with some aspects of the disclosure. The system 200 may include a supply chain 202 (e.g., the supply chain 102 of FIG. 1).

In the example of FIG. 2, operation of the supply chain 202 may include producing ingredients (such as unprocessed or “raw” ingredients, partially processed ingredients, or other ingredients), at 204. The ingredients may be produced by providers 208 (e.g., one or more farms, one or more mines, one or more other providers, or a combination thereof) of. In some examples, the ingredients include or correspond to the substances 142, 146 of FIG. 1.

Operation of the supply chain 202 may also include producing, based on the ingredients, one or more assemblies, one or more components, one or more combined ingredients, or a combination thereof, at 212. For example, multiple ingredients may be combined to produce a nutraceutical product.

Operation of the supply chain 202 may further include manufacturing and packaging, at 216. As an illustrative example, the nutraceutical product may be encapsulated (e.g., using a hard-shell encapsulation process, a soft-shell encapsulation process, or another process) to produce an encapsulated product, and the encapsulated product may be packaged to create a product (e.g., the product 144 of FIG. 1).

Operation of the system 200 may include distributing, by a retailer 220, the product to one or more consumers 224. In some examples, the retailer 220 corresponds to or is included in the one or more product distributors 160 of FIG. 1, and the one or more consumers 224 correspond to the first consumer 170, the second consumer 180 of FIG. 1, one or more other consumers, or a combination thereof.

Operation of the system 200 may further include providing, by the one or more consumers 224, information to the retailer 220, at 228. For example, the one or more consumers 224 may provide any of the product identification information 172, 182, the consumer information 176, 186, other information, or a combination thereof. In some examples, the one or more consumers 224 provide the information in exchange for receiving an incentive, at 232. For example, the incentive may include a financial incentive (e.g., a discount, a coupon, or money), a free product, or another incentive.

Operation of the system 200 may further include providing, by the one or more consumers 224, information to one or more parties of the supply chain 202, at 236. For example, the one or more consumers 224 may provide any of the product identification information 172, 182, the consumer information 176, 186, other information, or a combination thereof. In some examples, the one or more consumers 224 provide the information in exchange for receiving an incentive, at 240. For example, the incentive may include a financial incentive (e.g., a discount, a coupon, or money), a free product, or another incentive.

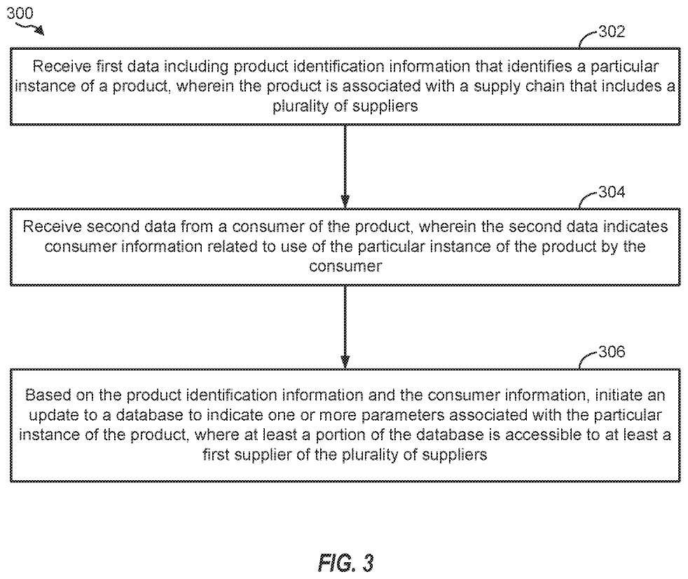

FIG. 3 is a flow chart of a method 300 in accordance with some aspects of the disclosure. In one example, operations of the method 300 are performed by the producer system 140. In other examples, operations of the method 300 may be performed by another device, such as a device of the first supplier 110, a device of the second supplier 120, a device of another party of the supply chain 102 or the supply chain 202, or a device of the one or more product distributors 160, as illustrative examples.

The method 300 includes receiving first data including product identification information that identifies a particular instance of a product, at 302. The product is associated with a supply chain that includes a plurality of suppliers. For example, the first data may include the first product identification information 172, the second product identification information 182, or both. The first product identification information 172 may identify the first instance 162 of the product 144, and the second product identification information 182 may identify the second instance 164 of the product 144. The product 144 may be associated with the supply chain 102, which may include the first supplier 110 and the second supplier 120.

The method 300 further includes receiving second data from a consumer of the product, at 304. The second data indicates consumer information related to use of the particular instance of the product by the consumer. For example, the second data may include the first consumer information 176 relating to use of the first instance 162 of the product 144 by the first consumer 170. Alternatively or in addition, the second data may include the second consumer information 186 relating to use of the second instance 164 of the product 144 by the second consumer 180.

The method 300 further includes, based on the product identification information and the consumer information, initiating an update to a database to indicate one or more parameters associated with the particular instance of the product, at 306. At least a portion of the database is accessible to at least a first supplier of the plurality of suppliers. For example, the database 134 may be updated based on any of the first product identification information 172, the second product identification information 182, the first consumer information 176, or the second consumer information 186. The one or more parameters may include information of any of the first product identification information 172, the second product identification information 182, the first consumer information 176, or the second consumer information 186. The first supplier 110 may access the updated database 134, such as in order to determine the first quality metric 114, the second quality metric 116, or both.

In some aspects, a system includes a memory (e.g., the memory 152) and one or more processors (e.g., the processor 150) configured to perform one or more operations described herein. The operations may include operations of the method 300.

In some aspects of the disclosure, a non-transitory computer-readable storage medium (e.g., the memory 152) stores instructions (e.g., the instructions 156) that, when executed by one or more processors (e.g., the processor 150), cause the one or more processors to perform one or more operations described herein. The operations may include operations of the method of 300.

To further illustrate certain aspects of the disclosure, in one example, a consumer compensation framework may enable proliferation of customer information and experience associated with a specific product (e.g., the product 144). The consumer compensation framework may incentivize the customer to share the information to upstream suppliers or other interested parties. A digital identity of the consumer may be linked to the purchased product. The customer may allow the suppliers and other interested parties to access the consumer information (e.g., age, gender, ethnicity, health information, other information, or a combination thereof) and information related to experience of the consumer with the product. In certain examples, compensation may be provided to the customer each time that the customer shares information. In some implementations, such data may be provided to one or more parties that helped to create the data, such as one or more suppliers of a supply chain. In some examples, the data is anonymized. As a result, in some implementations, a platform facilitates exchange of aggregated, anonymized, industry-wide (or platform-wide) data with platform participants, which may be in exchange for consumer compensation or agreeing to share the aggregated, anonymized data with other platform participants. In some implementations, the platform enables transparent product tracking and verification (e.g., a “seed-to-health” tracking and verification.

In some examples, upon scanning a QR code (which may correspond to the first barcode 166 or the second barcode 168) of a product (e.g., the product 144), a consumer receives an opportunity to share information related to the consumer, information related to the experience of the consumer with the product, or both. The consumer may be incentivized to share the information in exchange for compensation. The information may be associated with a specific instance (e.g., “batch”) of the product. As a result, a specific health outcome may be associated with specific ingredients and respective sources of the ingredients, thus enabling or increasing value chain transparency. Further, in some examples, suppliers, retailers, manufacturers, or other parties may offer discounts, coupons, credit, cash, or other incentives in exchange for such consumer information.

Thus, in some examples, a multi-ingredient product genealogy may be combined with consumer-specific information. As a result, the multi-ingredient product genealogy may indicate a particular consumer (or certain information associated with the consumer) of a product as well as details related to manufacturing, raw materials, and processes associated with the product. Further, the consumer may be granted control of the consumer information and may receive compensation for sharing information related to use of the product by the consumer, personal information related to the consumer, or both.

Although some aspects of the disclosure have been described using certain examples, it should be understood that various changes, substitutions, and alterations can be made to such aspects without departing from the scope of the disclosure. Moreover, the scope of the disclosure is not intended to be limited to the particular examples of the processes, machines, manufacture, compositions of matter, means, methods, and steps described in the specification. As one of ordinary skill in the art will appreciate, processes, machines, manufacture, compositions of matter, means, methods, or steps, presently existing or later to be developed, that perform substantially the same function or achieve substantially the same result as the corresponding examples described herein may be utilized. Accordingly, the appended claims are intended to include within their scope such processes, machines, manufacture, compositions of matter, means, methods, or steps. Moreover, the scope of the disclosure is not intended to be limited to the particular examples of the processes, machines, manufacture, compositions of matter, means, methods and steps described in the specification.

What is claimed is:

1. A method comprising:
receiving first data including product identification information that identifies a particular instance of a product, wherein the product is associated with a supply chain that includes a plurality of suppliers;
receiving second data from a consumer of the product, wherein the second data indicates consumer information related to use of the particular instance of the product by the consumer; and
based on the product identification information and the consumer information, initiating an update to a database to indicate one or more parameters associated with the particular instance of the product, wherein at least a portion of the database is accessible to at least a first supplier of the plurality of suppliers.

2. The method of claim 1, wherein providing access to the portion of the database enables the first supplier to determine a quality metric associated with the particular instance of the product, and further comprising:
receiving an indication of the quality metric from the first supplier; and
performing a second update of the database in response to the indication of the quality metric.

3. The method of claim 1, further comprising:
detecting that a condition is satisfied based on receipt of the consumer information; and
based on detecting that the condition is satisfied, providing an incentive to the consumer.

4. The method of claim 1, further comprising providing access to a particular portion of the database to the consumer, wherein the particular portion indicates an authenticated history of the particular instance of the product.

5. The method of claim 4, wherein the product includes a plurality of substances sourced from the plurality of suppliers, and wherein the authenticated history includes data related to two or more substances of the plurality of substances.

6. The method of claim 1, wherein the consumer information indicates a health status information resulting from the use of the product by the consumer.

7. The method of claim 1, wherein the second data further indicates demographic information associated with the consumer.

8. The method of claim 1, wherein the first product identification information indicates a barcode that identifies the particular instance of the product.

9. The method of claim 1, wherein the database has a blockchain data structure.

10. A system comprising:
a memory; and
one or more processors coupled to the memory and configured to:
receive first data including product identification information that identifies a particular instance of a product, wherein the product is associated with a supply chain that includes a plurality of suppliers;
receive second data from a consumer of the product, wherein the second data indicates consumer information related to use of the particular instance of the product by the consumer; and
based on the product identification information and the consumer information, initiate an update to a database to indicate one or more parameters associated with the particular instance of the product, wherein at least a portion of the database is accessible to at least a first supplier of the plurality of suppliers.

11. The system of claim 10, wherein providing access to the portion of the database enables the first supplier to determine a quality metric associated with the particular instance of the product, and wherein the one or more processors are further configured to:
receive an indication of the quality metric from the first supplier; and
perform a second update of the database in response to the indication of the quality metric.

12. The system of claim 10, wherein the one or more processors are further configured to:
detect that a condition is satisfied based on receipt of the consumer information; and
based on detecting that the condition is satisfied, provide an incentive to the consumer.

13. The system of claim 10, wherein the one or more processors are further configured to provide access to a particular portion of the database to the consumer, wherein the particular portion indicates an authenticated history of the particular instance of the product.

14. The system of claim 13, wherein the product includes a plurality of substances sourced from the plurality of suppliers, and wherein the authenticated history includes data related to two or more substances of the plurality of substances.

15. The system of claim 10, wherein the consumer information indicates a health status information resulting from the use of the product by the consumer.

16. The system of claim 10, wherein the second data further indicates demographic information associated with the consumer.

17. The system of claim 10, wherein the first product identification information indicates a barcode that identifies the particular instance of the product.

18. The system of claim 10, wherein the database has a blockchain data structure.

19. A non-transitory computer-readable storage medium storing instructions that, when executed by one or more processors, cause the one or more processors to perform operations, the operations comprising:
receiving first data including product identification information that identifies a particular instance of a product, wherein the product is associated with a supply chain that includes a plurality of suppliers;
receiving second data from a consumer of the product, wherein the second data indicates consumer information related to use of the particular instance of the product by the consumer; and
based on the product identification information and the consumer information, initiating an update to a database to indicate one or more parameters associated with the particular instance of the product, wherein at least a portion of the database is accessible to at least a first supplier of the plurality of suppliers.

20. The non-transitory computer-readable storage medium of claim 19, wherein providing access to the portion of the database enables the first supplier to determine a quality metric associated with the particular instance of the product, and wherein the operations further comprise:
receiving an indication of the quality metric from the first supplier; and
performing a second update of the database in response to the indication of the quality metric.
